(19) United States
(12) Patent Application Publication
(10) Pub. No.: US 2026/0174274 A1
(43) Pub. Date: Jun. 25, 2026

(54) BEVERAGE-MAKING MACHINE WITH VACUUM BREAK VALVE

(71) Applicant: Hamilton Beach Brands, Inc., Glen Allen, VA (US)

(72) Inventor: Adam Hanes, Glen Allen, VA (US)

(73) Assignee: Hamilton Beach Brands, Inc., Glen Allen, VA (US)

(21) Appl. No.: 18/990,821

(22) Filed: Dec. 20, 2024

(51) Int. Cl. A47J 31/46; A47J 31/36; A47J 31/54; F16K 17/02

(52) U.S. Cl. CPC A47J 31/461; A47J 31/3695; A47J 31/545; F16K 17/02

(57) ABSTRACT

A beverage-making including a controller operatively connected with a hot water generator and a pump; a vacuum break valve fluidly connected with the hot water generator and the dispensing needle. The vacuum break valve is configured to move between open and closed positions, wherein in the closed position the valve provides a seal that maintains a substantially airtight path between the hot water generator and the dispensing needle, and wherein in the open position the valve opens to vent the path between the hot water generator and the dispensing needle.

### FIELD OF THE INVENTION

The present invention relates generally to small appliances, and more specifically to beverage makers.

### BACKGROUND

Automatic drip coffeemakers are well known and widely used. They are effective to brew carafes of coffee, typically containing five to eight cups or more of liquid. Automatic coffee makers may also be used for brewing small batches (one to four cups).

One variety of automatic coffeemaker is configured to brew coffee using coffee grounds that are included within a hard-shelled “pod”-type package. The pod is included in a brew chamber located near the top of the coffeemaker. Heated water is conveyed at elevated pressure to a needle that punctures the upper surface of the pad. The elevated pressure heated water is forced into the pod through the needle. Brewed beverage exits the lower end of the pod (which is also punctured when the pod is fully loaded into the brew chamber) and flows into a vessel (e.g., a mug or carafe) positioned on a receiving stage of the coffeemaker. Exemplary automatic coffeemakers that utilize pods are discussed in U.S. Pat. Nos. 10,595,668; 11,395,558; and 11,771,259, the disclosures of which are hereby incorporated herein by reference in full.

One issue that can arise with some pod-style coffeemakers is the accumulation of grounds from the pod within the needle. Such accumulation can occur due to the system inadvertently developing a vacuum in the pod during the brewing process with certain types of heaters (e.g., flow-through heaters, and in particular U-shaped flow-through heaters) that are often used for the brewing of pods. Typically, the unwanted vacuum is created when steam generated by the heater inadvertently condenses between the heater and the dispensing needle. The vacuum can cause grounds in the pod to be drawn upwardly through the inlet of the dispensing needle. The grounds can either become stuck in the needle itself or gather upstream of the needle where they clog the needle inlet. In either event, the presence of the grounds can impede or even prevent operation.

In view of the foregoing, it may be desirable to provide a coffeemaker that can address this issue.

### SUMMARY

As a first aspect, embodiments of the invention are directed to a beverage-making machine that can address the issue of unwanted suction described above. The beverage-making machine includes a housing comprising: a base; a tower extending upwardly from the base; and a dispensing arm that extends from the tower. The beverage-making machine further comprises: a water reservoir mounted on the housing; a brew chamber positioned in the dispensing arm and above the vessel receiving area; a hot water generator fluidly connected with the water reservoir; a pump fluidly connected with the water reservoir; a dispensing needle fluidly connected with the pump and the hot water generator and positioned to dispense heated water into the brew chamber; a controller operatively connected with the hot water generator and the pump; and a vacuum break valve fluidly connected with the hot water generator and the dispensing needle. The vacuum break valve is configured to move between open and closed positions, wherein in the closed position the valve provides a seal that maintains a substantially airtight path between the hot water generator and the dispensing needle, and wherein in the open position the valve opens to vent the path between the hot water generator and the dispensing needle to atmospheric pressure. The valve moves from the closed position to the open position when exposed to negative pressure in the path between the dispensing needle and the hot water generator, the negative pressure exceeding a predetermined magnitude.

As a second aspect, embodiments of the invention are directed to a beverage-making machine that includes a housing comprising: a base with a vessel receiving area; a tower extending upwardly from the base; and a dispensing arm that extends from the tower at least partially directly above the vessel receiving area. The beverage-making machine further comprises: a water reservoir mounted on the housing; a brew chamber positioned in the dispensing arm and above the vessel receiving area, the brew chamber configured to receive a hard-shelled pod of grounds for brewing; a flow-through hot water heater fluidly connected with the water reservoir; a pump fluidly connected with the water reservoir; a dispensing needle fluidly connected with the pump and the flow-through hot water heater and positioned to dispense heated water into the brew chamber; a controller operatively connected with the flow-through hot water heater and the pump; and a vacuum break valve fluidly connected with the flow-through hot water heater and the dispensing needle. The vacuum break valve is configured to move between open and closed positions, wherein in the closed position the valve provides a seal that maintains a substantially airtight path between the flow-through hot water heater and the dispensing needle, and wherein in the open position the valve opens to vent the path between the flow-through hot water heater and the dispensing needle to atmospheric pressure. The valve moves from the closed position to the open position when exposed to negative pressure in the path between the dispensing needle and the flow-through hot water heater, the negative pressure exceeding a predetermined magnitude.

As a third aspect, embodiments of the invention are directed to a beverage-making machine that includes a housing comprising: a base with a vessel receiving area; a tower extending upwardly from the base; and a dispensing arm that extends from the tower at least partially directly above the vessel receiving area. The beverage-making machine further comprises: a water reservoir mounted on the housing; a brew chamber positioned in the dispensing arm and above the vessel receiving area, the brew chamber configured to receive a hard-shelled pod of grounds for brewing; a hot water generator fluidly connected with the water reservoir; a pump fluidly connected with the water reservoir; a dispensing needle fluidly connected with the pump and the hot water generator and positioned to dispense heated water into the brew chamber; a controller operatively connected with the hot water generator and the pump; and a vacuum break valve fluidly connected with the hot water generator and the dispensing needle. The vacuum break valve is configured to move between open and closed positions, wherein in the closed position the valve provides a seal that maintains a substantially airtight path between the hot water generator and the dispensing needle, and wherein in the open position the valve opens to vent the path between the hot water generator and the dispensing needle to atmospheric pressure. The valve moves from the closed position to the open position when exposed to negative pressure in the path between the dispensing needle and the hot water generator, the negative pressure exceeding a predetermined magnitude of between about 0.05 and 0.5 psi.

### BRIEF DESCRIPTION OF THE FIGURES

FIG. 1 is a perspective view of a coffeemaker according to embodiments of the invention.

FIG. 2 is a schematic diagram of components of the coffeemaker of FIG. 1.

FIG. 3 is a schematic perspective diagram of an alternative arrangement of components of the coffeemaker of FIG. 1.

FIGS. 4A and 4B are schematic cross-sections of an exemplary umbrella valve that can be employed in the coffeemaker of FIG. 1.

FIG. 5 is a partial rear section view of the vacuum break valve employed in the coffeemaker of FIG. 1.

FIG. 6 is an enlarged partial rear section view of the vacuum brake valve of FIG. 5.

FIG. 7 is a schematic diagram of components of an alternative coffeemaker according to embodiments of the invention.

### DETAILED DESCRIPTION

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

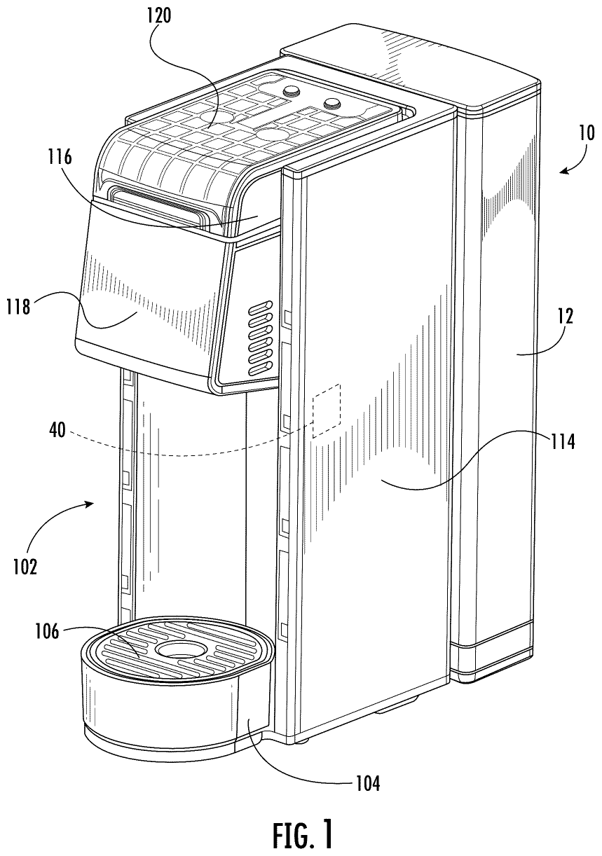

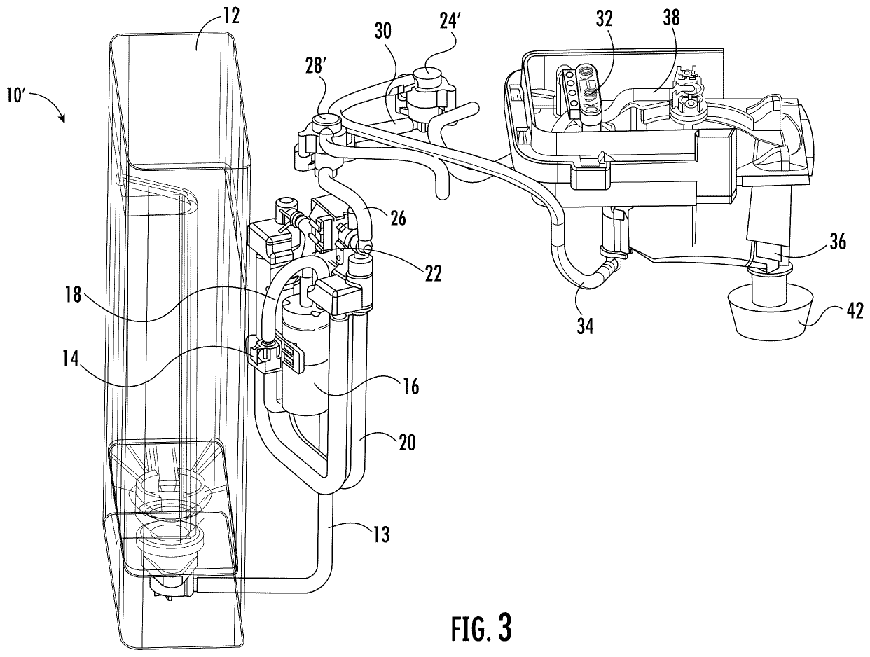

Referring now to the figures, a coffeemaker according to embodiments of the invention is designated broadly at 10 and shown in FIG. 1. The coffeemaker 10 has an outer housing 102 that includes a base 104 with a vessel receiving area 106. The housing 102 also includes a vertical tower 114 that rises rearwardly from the base 104. A dispensing arm 116 is cantilevered forwardly from the tower 114 and overhangs the base 104. A cover 120 is pivotally attached at the top of the dispensing arm 116 to allow for loading and unloading of hard-shelled pods into a brew chamber 42 (shown schematically in FIG. 3).

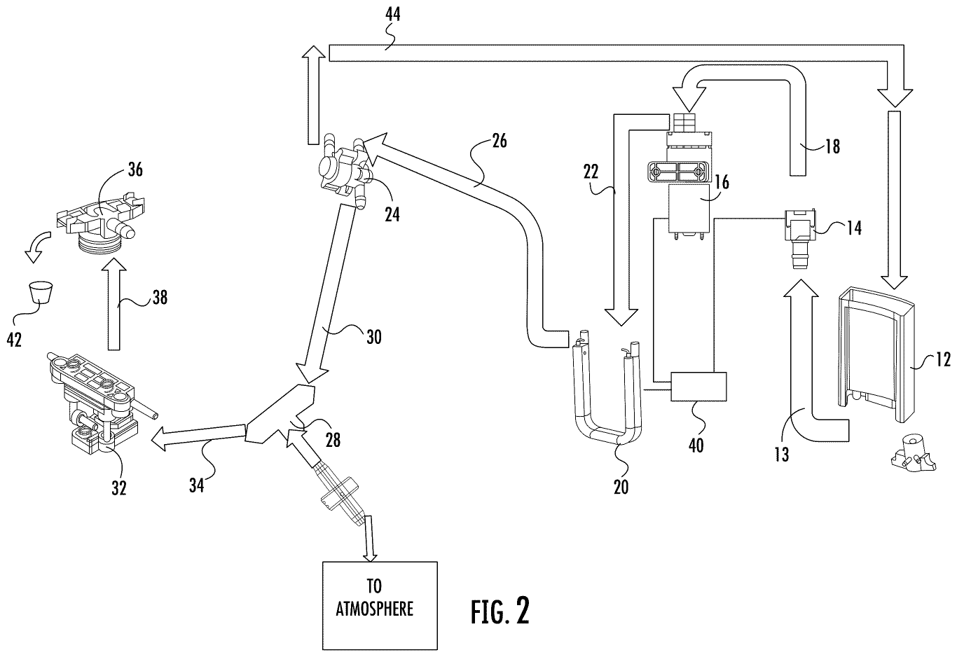

A control panel 118 is mounted on the front surface of the dispensing arm 116 and includes buttons, touch screens, or the like to enable the user to operate the coffeemaker 10 and to make specific operation selections. The control panel 118 is operatively connected with a controller 40 (typically in the form of a printed circuit board or the like—shown schematically in FIGS. 1 and 2)) mounted within the housing 102.

Referring now to FIG. 2, operational components of the coffeemaker 10 that are mounted within or on the housing 102 are shown therein. The coffeemaker 10 includes a cold water reservoir 12, a flow meter 14 connected with the water reservoir 12 via a line 13, a cold water pump 16 that is fluidly connected with the flow meter 14 via a line 18, a hot water generator 20 (e.g., a heater, and in some instances a flow-through heater such as the U-shaped heater depicted in FIG. 2) that is fluidly connected to the cold water pump 16 via a line 22, a pressure relief valve 24 that is fluidly connected to the hot water generator 20 via a line 26, a vacuum break valve 28 that is fluidly connected to the pressure relief valve 24 via a line 30, a pinch valve 32 that is fluidly connected to the vacuum break valve 28 via a line 34, and a dispensing needle 36 that is fluidly connected to the pinch valve 32 via a line 38 (in some instances, the lines 34, 38 can constitute a single hose or tube, with the pinch valve 32 simply compressing the hose to stop flow). The path between the hot water generator 20 and the dispensing needle 36 is substantially airtight. The dispensing needle 36 is configured to dispense pressurized hot water into a pod contained in the brew chamber 42 that is mounted in the dispensing arm 116. The flow meter 14, the pump 16, and the hot water generator 20 are all operatively connected with the controller 40 (see FIG. 2).

Still referring to FIG. 2, the pressure relief valve 24 is fluidly connected with the water reservoir 12 via a line 44 to return water in the system to the water reservoir 12 if the pressure created by the pump 16 exceeds a certain magnitude (e.g., 6-11 psi). Also, the vacuum break valve 28 is fluidly connected with the interior of the housing 102, which provides an outlet to the atmosphere (i.e., to atmospheric pressure). (The vacuum break valve 28 may also be fluidly connected to the exterior of the housing 12, which would also provide an outlet to the atmosphere).

In operation, a user fills the water reservoir 12 with water, fills the brew chamber 42 with a hard-shelled pod containing grounds, positions a receiving vessel (e.g., a mug) on the vessel receiving area 106, and through the control panel 118 activates the brewing process. Water travels from the water reservoir 12 through the line 13 to the flow meter 14, which monitors water flow and communicates with the controller 40. Water proceeds to the pump 16 through the line 18, which pumps water via the line 22 through the hot water generator 20 (both of which are monitored and controlled by the controller 40). The pressurized hot water then travels through the line 26 to the pressure relief valve 24, through the line 30 to the vacuum break valve 28, through the pinch valve 32 via the line 34, and to the dispensing needle 36 through the line 38. The process ceases when the desired amount of beverage has been brewed into the vessel.

As described above, in some instances, during operation of prior coffeemakers of this type, a vacuum can develop in the lines 26, 30, 34 between the hot water generator 20 and the dispensing needle 36 (which are substantially airtight) that can suck solid grounds from the hard-shelled pod back into the dispensing needle 36. This action can impede or prevent water flow into and out of the dispensing needle 36, thereby impacting brewing. This vacuum can be of a relatively low level (e.g., 0.01-1 psi), but can still lead to the undesirable formation of clogged grounds in the system. Further, the presence of the pinch valve 32 (which is included to ensure that water does not spray from the needle when the cover 120 is opened) can contribute to clogging due to grounds once some grounds have been sucked back into the line 38 (this is particularly prevalent if a single hose is used for lines 34, 38, as pinching of the hose can cause it to “neck down” even when the pinch valve 32 valve is open).

This problem can be addressed by the inclusion of the vacuum break valve 28. The vacuum break valve 28 is configured such that low negative pressure (i.e., suction) inadvertently experienced in the dispensing needle 36 is relieved, thereby preventing clogs. More specifically, the vacuum break valve 28 is a one-way valve that is fluidly connected with the line(s) 26, 30, 34, 38 between the hot water generator 20 and the dispensing needle 36 and that opens in the presence of a predetermined magnitude of negative pressure. Thus, when suction inadvertently develops in the pathway between the hot water generator 20 and the dispensing needle 36 above the predetermined magnitude, the vacuum break valve 28 opens to the atmosphere to release the suction and prevent grounds from being conveyed via suction from the pod into the dispensing needle 36.

FIG. 3 illustrates an alternative configuration for a coffeemaker, designated at 10′, which is identical to the coffeemaker 10 with the exception that the vacuum break valve 28′ is positioned between the hot water generator 20 and the pressure relief valve 24′. Because the undesired suction discussed above typically develops between the hot water generator 20 and the dispensing needle 36, placement of the vacuum break valve anywhere on the fluid path between these two components can provide the desired vacuum break function.

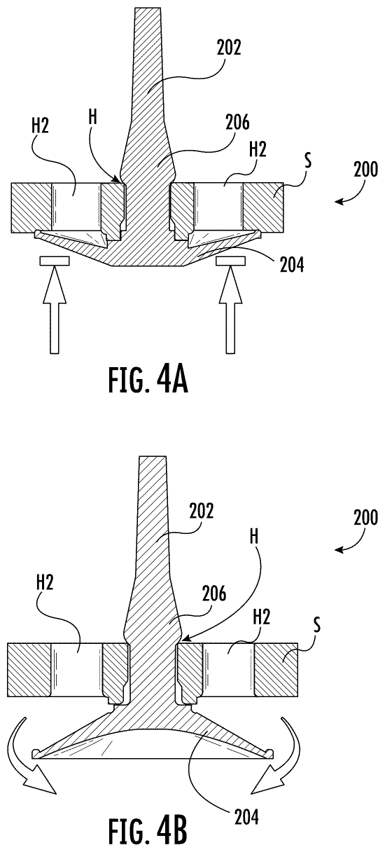

FIGS. 4A and 4B illustrate one variety of vacuum break valve 28 that may be employed in the coffeemaker 10. As can be seen in FIG. 4A, the vacuum break valve 28 can be an “umbrella” valve 200, which includes a shaft 202, a diaphragm 204, and a nub 206 on the shaft 202. As shown in FIG. 4A, an umbrella valve 200 is deployed by inserting the shaft 204 into a hole H in a structure S such that the nub 206 is on one side of the structure S and the diaphragm 204 is on the opposite side. In this position, the diaphragm 204 covers, and therefore seals, holes H2 that surround the hole H; however, in many configurations, the diaphragm 204 is “pre-loaded,” such that it is urged toward an inverted condition. When negative pressure is applied to the diaphragm 204 above a specific magnitude, the diaphragm 204 (aided by the aforementioned pre-loading) inverts (FIG. 4B), thereby unsealing the holes H2 and releasing the suction.

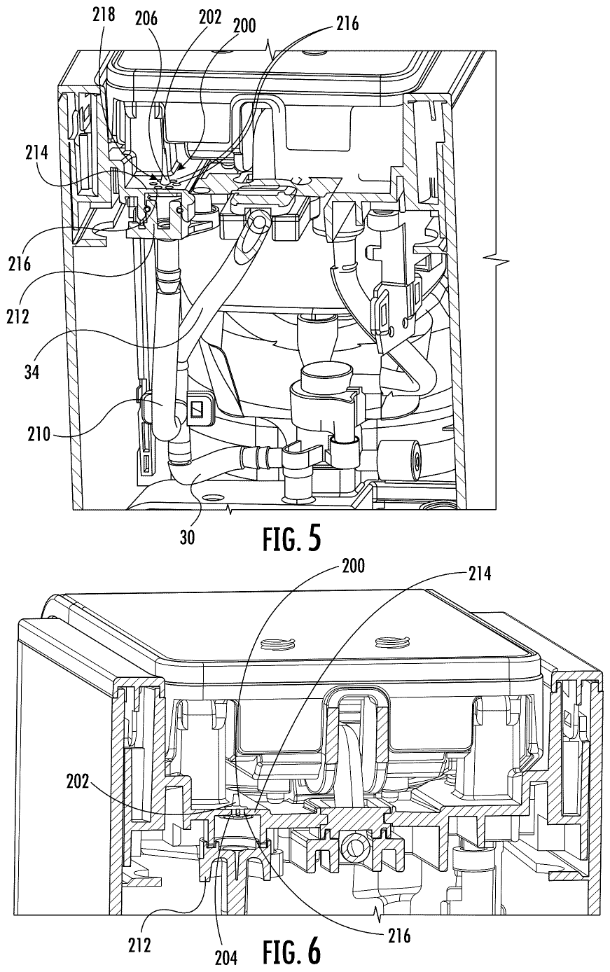

FIGS. 5 and 6 illustrate a deployment of the umbrella valve 200 in the coffeemaker 10. Specifically, a branch line 210 in communication with the lines 30, 34 between the pressure relief valve 24 and the pinch valve 32 is routed to a hollow fitting 212 that is mounted under and sealed against a surface 214 within the housing 102. The umbrella valve 200 is oriented so that the diaphragm 204 is below the surface 214 and covers holes 216 in the surface 214. The volume within the housing 12 above the surface 214 is at atmospheric pressure. The shaft 202 of the umbrella valve 200 extends through a hole 218 in the surface 214; the nub 206 of the umbrella valve 200 is above the surface 214 and maintains the umbrella valve 200 in place.

When either neutral or positive pressure is present in the lines 26, 30, 34, 38, this pressure level is maintained in the branch line 210 and the fitting 212, with the result that the diaphragm 204 covers the holes 216 in the surface 214. However, in the event that negative pressure (i.e., suction) develops in the lines 26, 30, 34, 38 as described above, the branch line 210 and fitting 212 experience that suction. If the suction reaches a predetermined threshold magnitude for the umbrella valve 200 (e.g., 0.55 to 5 psi), the suction forces the diaphragm 204 to invert, which uncovers the holes 216 that lead to atmospheric pressure, thereby releasing the suction from the lines 26, 30, 34, 38. As a result, any suction at the dispensing needle 36 is released, such that no grounds are sucked from the pod into the dispensing needle 36 to clog it.

Those of skill in this art will appreciate that other valve configurations may be employed as the vacuum brake valve 28. For example, a spring-loaded valve that opens at a threshold pressure may substituted in place of the umbrella valve 200 shown herein (such a valve is shown schematically in FIG. 2). Similarly, a “reverse check” valve may also be employed. Examples of these valve types include the DW 10 valve, available from Neoperl International, Inc., and “duckbill” valves, available from Minivalve International.

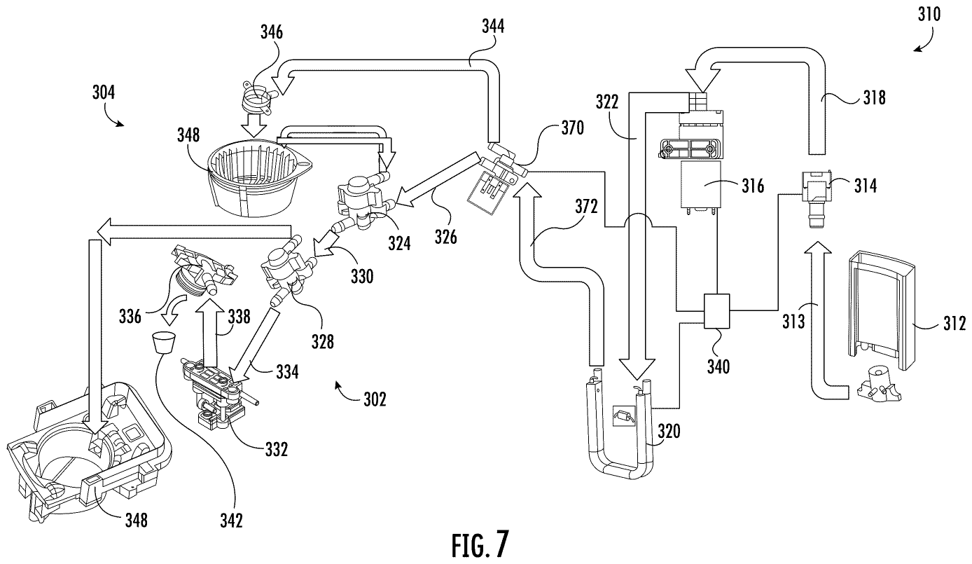

In addition, the vacuum brake valve may be employed in beverage-making machines that include multiple stations for making beverages. FIG. 7 is a schematic illustration of a coffeemaker, designated broadly at 310, that includes both a “pod” style brewing station 302 and a “showerhead” style brewing station 304 as parts of the same coffeemaking machine. As shown in FIG. 7, the coffeemaker 310 includes a cold-water reservoir 312, a flow meter 314 connected with the water reservoir 312 via a line 313, a cold-water pump 316 that is fluidly connected with the flow meter 314 via a line 318, and a hot water generator 320 that is fluidly connected to the cold-water pump 316 via a line 322. The coffeemaker 310 also includes a valve 370 (shown herein as a solenoid valve) that directs the flow of hot water from the hot water generator 320 to either the pod-style brewing station 302 or the showerhead-style brewing station 304. The valve 370 is fluidly connected with the hot water generator 320 via a line 372. The route from the valve 370 to the pod-style brewing station 302 includes a pressure relief valve 324 that is fluidly connected to the solenoid valve 370 via a line 326, a vacuum break valve 328 that is fluidly connected to the pressure relief valve 324 via a line 330, a pinch valve 332 that is fluidly connected to the vacuum break valve 328 via a line 334, and a dispensing needle 336 that is fluidly connected to the pinch valve 332 via a line 338. Like the dispensing needle 36 described above, the dispensing needle 336 is configured to dispense pressurized hot water into a pod contained in a brew chamber 342 that serves the pod-style brewing station 302. A line 344 is routed from the valve 370 to the showerhead 346 of showerhead-style brewing station 304, which dispenses hot water into a brew chamber 348.

As described above for the coffeemaker 10, the flow meter 314, the pump 316, and the hot water generator 320 are all operatively connected with the controller 340. In addition, the valve 370 is operatively connected with the controller 340.

In the coffeemaker 310, the vacuum break valve 328 is fluidly routed to the brew chamber 348 of the showerhead-style brew station 304, which provides a convenient location to expose the vacuum break valve 328, and in turn the remainder of the components between the hot water generator 320 and the dispensing needle 336, to atmospheric pressure to eliminate any suction that is generated therein. However, those of skill in this art will appreciate that other locations within the coffeemaker 310 that are exposed to atmospheric pressure may also serve as exposure points to relieve suction via the vacuum break valve 328.

It will also be recognized that many of the other components of the coffeemakers discussed above (e.g., the hot water generator, the flow meter, the pump) may be replaced with units that perform a similar function. Also, these components may be arranged differently within their respective housings.

Finally, those of skill in this art will appreciate that the coffeemakers 10, 210 may be employed to brew other beverages, such as tea, hot chocolate, etc. As such, the terms “coffeemaker,” “beverage maker”, beverage-making machine,” and the like are intended to be interchangeable.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A beverage-making machine, comprising:
a housing comprising:
a base;
a tower extending upwardly from the base; and
a dispensing arm that extends from the tower;
a water reservoir mounted on the housing;
a brew chamber positioned in the dispensing arm;
a hot water generator fluidly connected with the water reservoir;
a pump fluidly connected with the water reservoir;
a dispensing needle fluidly connected with the pump and the hot water generator and positioned to dispense heated water into the brew chamber;
a controller operatively connected with the hot water generator and the pump; and
a vacuum break valve fluidly connected with the hot water generator and the dispensing needle, the valve configured to move between open and closed positions, wherein in the closed position the valve provides a seal that maintains a substantially airtight path between the hot water generator and the dispensing needle, and wherein in the open position the valve opens to vent the path between the hot water generator and the dispensing needle to atmospheric pressure, and wherein the valve moves from the closed position to the open position when exposed to negative pressure in the path between the dispensing needle and the hot water generator, the negative pressure exceeding a predetermined magnitude.

2. The beverage-making machine defined in claim 1, wherein the predetermined magnitude is between about 0.05 and 5 psi.

3. The beverage-making machine defined in claim 1, wherein the vacuum break valve comprises an umbrella valve.

4. The beverage-making machine defined in claim 1, wherein the hot water generator comprises a flow-through heating unit.

5. The beverage-making machine defined in claim 1, wherein the brew chamber is configured to receive a hard-shelled pod of grounds for brewing.

6. The beverage-making machine defined in claim 1, further comprising a pinch valve fluidly connected between the vacuum break valve and the dispensing needle.

7. The beverage-making machine defined in claim 1, further comprising a pressure relief valve fluidly connected between the hot water generator and the dispensing needle.

8. The beverage-making machine defined in claim 7, wherein the vacuum break valve is disposed on a fluid line between the pressure relief valve and the dispensing needle.

9. A beverage-making machine, comprising:
a housing comprising:
a base with a vessel receiving area;
a tower extending upwardly from the base; and
a dispensing arm that extends from the tower at least partially directly above the vessel receiving area;
a water reservoir mounted on the housing;
a brew chamber positioned in the dispensing arm and above the vessel receiving area, the brew chamber configured to receive a hard-shelled pod of grounds for brewing;
a flow-through heater fluidly connected with the water reservoir;
a pump fluidly connected with the water reservoir;
a dispensing needle fluidly connected with the pump and the flow-through heater and positioned to dispense heated water into the brew chamber;
a controller operatively connected with the flow-through heater and the pump; and
a vacuum break valve fluidly connected with the flow-through heater and the dispensing needle; the valve configured to move between open and closed positions, wherein in the closed position the valve provides a seal that maintains a substantially airtight path between the flow-through heater and the dispensing needle, and wherein in the open position the valve opens to vent the path between the flow-through heater and the dispensing needle to atmospheric pressure, and wherein the valve moves from the closed position to the open position when exposed to negative pressure in the path between the dispensing needle and the flow-through heater, the negative pressure exceeding a predetermined magnitude.

10. The beverage-making machine defined in claim 9, wherein the predetermined magnitude is between about 0.05 and 5 psi.

11. The beverage-making machine defined in claim 9, wherein the vacuum break valve comprise an umbrella valve.

12. The beverage-making machine defined in claim 9, further comprising a pinch valve fluidly connected between the vacuum break valve and the dispensing needle.

13. The beverage-making machine defined in claim 9, further comprising a pressure relief valve fluidly connected between the hot water generator and the dispensing needle.

14. The beverage-making machine defined in claim 13, wherein the vacuum break valve is disposed on a fluid line between the pressure relief valve and the dispensing needle.

15. The beverage-making machine defined in claim 9, wherein the flow-through heater comprises a generally U-shaped heating unit.

16. A beverage-making machine, comprising:
a housing comprising:
a base with a vessel receiving area;
a tower extending upwardly from the base; and
a dispensing arm that extends from the tower at least partially directly above the vessel receiving area;
a water reservoir mounted on the housing;
a brew chamber positioned in the dispensing arm and above the vessel receiving area, the brew chamber configured to receive a hard-shelled pod of grounds for brewing;
a hot water generator fluidly connected with the water reservoir;
a pump fluidly connected with the water reservoir;
a dispensing needle fluidly connected with the pump and the hot water generator and positioned to dispense heated water into the brew chamber;
a controller operatively connected with the hot water generator and the pump; and
a vacuum break valve fluidly connected with the hot water generator and the dispensing needle; the valve configured to move between open and closed positions, wherein in the closed position the valve provides a seal that maintains a substantially airtight path between the hot water generator and the dispensing needle, and wherein in the open position the valve opens to vent the path between the hot water generator and the dispensing needle to atmospheric pressure, and wherein the valve moves from the closed position to the open position when exposed to negative pressure in the path between the dispensing needle and the hot water generator, the negative pressure exceeding a predetermined magnitude of between about 0.05 and 5 psi.

17. The beverage-making machine defined in claim 1, wherein the vacuum break valve comprises an umbrella valve.

18. The beverage-making machine defined in claim 1, wherein the hot water generator comprises a flow-through heating unit.

19. The beverage-making machine defined in claim 1, further comprising a pinch valve fluidly connected between the vacuum break valve and the dispensing needle.

20. The beverage-making machine defined in claim 1, further comprising a pressure relief valve fluidly connected between the hot water generator and the dispensing needle.

21. The beverage-making machine defined in claim 7, wherein the vacuum break valve is disposed on a fluid line between the pressure relief valve and the dispensing needle.
